(19) United States
(12) Patent Application Publication
(10) Pub. No.: US 2005/0166207 A1
(43) Pub. Date: Jul. 28, 2005

(54) Self-optimizing computer system

(75) Inventors: Takanobu Baba, Utsunomiya City (JP); Takashi Yokota, Utsunomiya City (JP); Kanemitsu Otsu, Utsunomiya City (JP)

Correspondence Address: OLIFF & BERRIDGE, PLC, P.O. BOX 19928, ALEXANDRIA, VA, 22320, US

(73) Assignee: NATIONAL UNIVERSITY CORPORATION UTSUNOMIYA UNIVERSITY, Utsunomiya City (JP)

(21) Appl. No.: 11/020,153

(22) Filed: Dec. 27, 2004

(30) Foreign Application Priority Data
Dec. 26, 2003 (JP) 2003-434625

(51) Int. Cl. G06F 9/46

(52) U.S. Cl. 718/105

(57) ABSTRACT

Provided is a self-optimizing computer system that can achieve ultimate optimization (improvement in the speed) by preparing a mechanism that can observe the behavior of the program execution in the self-optimizing computer system and optimize dynamically depending on the execution behavior of program. The self-optimizing computer system comprising multiple processing units, characterized in that each of the processing units operates as at least one of an operation processing unit for executing a program, an observation processing unit for observing the behavior of the program under execution, an optimization processing unit for performing an optimization process according to the observation result of the observation processing unit, and a resource management processing unit for performing a resource management process of whole of the system such as a change of the contents of execution.

### BACKGROUND OF THE INVENTION

1. Field of the Invention

The present invention relates to computer system, and more specially self-optimizing computer system comprising multiple processing units.

2. Related Art Statement

The multiple processing units are incorporated in single computer system, and a role depending on execution situation of a program is assigned to each of the processing units so that effective optimization can be performed and resulting processing speed can be improved.

As a first conventional technology, there is a multi-computer/multi-thread processor technology as described in JP 2003-30050 “multi-thread execution method and parallel processor system”. This technology realizes improvement of the speed by utilizing two kinds of parallelism using the multiple processing units. Specifically, these are the instruction level parallelism which executes two or more instructions simultaneously in a single processing unit, and the thread level parallelism which parallelizes using a instruction sequence (thread) as a unit. Improvement in the speed is realized by the combination of these two kinds of parallelism. In the parallel computer or the multithread computer system, in order to use effectively the multiple processing units incorporated so as to achieve improvement in the speed, it is indispensable to fully exploit the parallelism in each of a instruction level and a thread level (or parallel processing). However, since the general application program is not described to fully exploit the parallelism in these levels, there is a problem that parallelism extraction by the compiler cannot fully be performed. That is, even if there are the multiple processing units, it is a problem that it is difficult to realize high-speed processing or to maintain the high-speed processing by working them simultaneously in parallel.

As a second conventional technology, there is a static optimization/optimization compiler technology as described in JP2001-147820 “code optimization method and storing medium.” This technology realizes improvement in the speed by analyzing logically procedures described as a program, and applying said two kinds of parallelizing technology (the instruction level parallelism and the thread level parallelism). Another compiler technology is also used which improves the optimization effect by once executing the program and recording (profiling) the behavior of the program at that time. Although the optimization compiler tries to solve the parallelism extraction problem, there is a problem that the effect of optimization is limited, because the range analyzable at the time of compilation is limited generally. Moreover, although the method of acquiring the more advanced optimization effect based on the result of profiling is also used. However, since the program execution behavior information collected is the cumulative result through an observation period, the method just performs average improvement in the speed through the whole execution time is possible, and there is a problem that it cannot respond to the small change of the behavior. Moreover, when the execution in the program is dependent on input data, there is a problem that the speed improvement effect according to this technology may not be obtained.

As a third conventional technology, there is a dynamic optimization technology as described in JP 2002-222088 “compilation system, compilation method and program.” Also there is a technology that optimizes (or recompiles) the program code based on the information extracted during program execution. There is a technology that in order to perform the optimization depending on the dynamic behavior of the program, the behavior during the program execution is observed and a more suitable program code is generated if needed. Since this technology needs to add a process for behavior observation to the original application program, or to run a program for observation separately, the efficiency is degraded due to the overhead of observation cost in both cases. Furthermore, since the overhead for performing the optimization process is imposed during execution, there is a problem that the performance improvement according to the optimization is canceled.

It is desired that the performance is improved by changing the internal configuration of the computer or the code of the program depending on the execution behavior of the program. An object of the invention is to provide a self-optimizing computer system that can achieve ultimate optimization (improvement in the speed) by preparing a mechanism that can observe the program performed concurrently in the self-optimizing computer system and by performing dynamically the optimization depending on the execution behavior of program. In the invention, the computer system is assumed in that the multiple processing units having two or more arithmetic units respectively are arranged. The instruction level parallelism can be applied within the processing unit, and the parallel processing or the thread level parallelism can be applied by using the multiple processing units. The invention solves the problems about the conventional multithread type computer system mentioned above, and realizes the self-optimizing computer system for performing the optimization dynamically efficiently.

### SUMMARY OF THE INVENTION

The foregoing objects are achieved by a self-optimizing computer system comprising multiple processing units, characterized in that each of the processing units operates as at least one of an operation processing unit for executing a program, an observation processing unit for observing the behavior of the program under execution, an optimization processing unit for performing an optimization process according to the observation result of the observation processing unit, and a resource management processing unit for performing a resource management process of whole of the system such as a change of the contents of execution. That is, the observation processing unit group that does not execute the application program but performs behavior observation, observes state of the operation processing unit group that is in charge of execution of the application program originally made into the purpose, the optimization processing unit group performs optimization using the observation result of the observation processing unit group, and the resources management processing unit group performs the management and the control of the whole operation of the computer system.

An embodiment of a self-optimizing computer system according to the invention is characterized in that each of the processing units has a function that allows changing dynamically an execution state of the operation processing unit and the executed program itself, and the optimization processing unit generates an optimal program code in real time based on the observation result of the behavior of the program observed by the observation processing unit, and changes dynamically the execution procedures of the operation processing unit. Thereby, the application program can be executed with the optimal efficient code always.

Another embodiment of a self-optimizing computer system according to the invention is characterized in that a ratio of the numbers of the operation processing unit, the observation processing unit, the optimization processing unit, and resource management processing unit is changed depending on the optimization state of the program. In the state that the optimization less advanced yet, it can obtain the optimization code having an improved execution efficiency at an early stage by assigning the many processing units to observation processing and optimization processing, and optimization time is shortened. In the stage that the optimization more advanced, since there is no necessity of performing optimization more than it not much, the number of the processing units which are assigned to execution of the application program is increased more so that the processing speed can be improved more. In this way, the optimal role distribution depending on the execution state of the program can be performed. Moreover, even if once it becomes in the optimal state, the optimal state does not necessarily continue depending on the program, in this case, the observation processing unit group detects change of the behavior of the program, responds to the change at an early stage, and assigns the many processing units to the observation processing and the optimization processing again so that it can respond to the behavior change of the program at an early stage and obtain the optimal program code. The resources management processing unit group performs processing of such dynamic role changes.

Since the optimization can be performed while observing the execution state of the program in real time, the control for always taking out the maximum capability of hardware can be performed. The maximum extraction of the instruction level parallelism and thread level parallelism which are the purpose of the invention becomes possible by using the multiple identical processing units and maintaining always them in the optimal state by said optimization function. Furthermore, the function and the capability of the processing units in the system can be availed maximally by performing the role distribution of the processing units for executing the application program and the other processing units for observation, optimization and resources management, and allowing to change the role distribution depending on the state of the optimization. That is, in the state that the optimization advanced less, it is possible to obtain the optimization code at an early stage by concentrating on the observation processing of the program behavior and the optimization processing, and in the state that the optimization advanced more, it is possible to realize the maximum execution performance by concentrating on the execution of the application program which is original purpose. Moreover, by assigning the processing units which are not used for the operation processing to the functions of observation, optimization, and resources management, it becomes possible to perform dynamic optimization, without affecting the execution performance of the application program at all.

### BRIEF DESCRIPTION OF THE DRAWINGS

FIG. 1 is a block diagram showing a construction of an embodiment of a self-optimizing computer system according to the invention.

FIG. 2 is a block diagram showing a construction of a variation of the self-optimizing computer system shown in FIG. 1.

FIG. 3 is a block diagram explaining a fundamental concept of the self-optimizing computer system according to the invention.

FIG. 4 shows operation of each processing unit group of the self-optimizing computer system according to the invention in order of time.

FIG. 5 show the change of a role assignment of each processing unit of the self-optimizing computer system according to the invention.

FIG. 6 shows each organization shown in FIG. 5 based on FIG. 1.

FIG. 7 shows each organization shown in FIG. 5 based on FIG. 1.

FIG. 8 shows each organization shown in FIG. 5 based on FIG. 1.

FIG. 9 shows an example of arrangement of each processing unit group of the self-optimizing computer system according to the invention.

FIG. 10 shows another example of arrangement of each processing unit group of the self-optimizing computer system according to the invention.

### DETAILED DESCRIPTION OF THE PREFERRED EMBODIMENTS

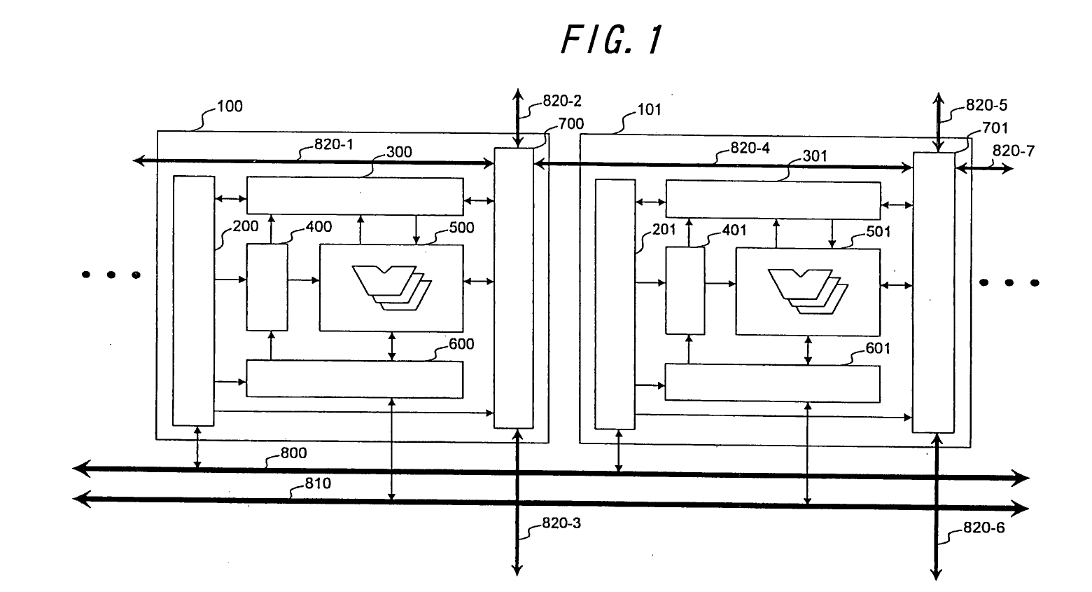

FIG. 1 is a block diagram showing an organization of an embodiment of a self-optimizing computer system according to the invention. This self-optimizing computer system comprises multiple processing units 100, 101 . . . For the sake of clarity, only the processing units 100 and 101 are shown in FIG. 1. The multiple processing units operate in parallel to extract both the instruction level parallelism and the thread level parallelism.

Typically, the processing unit 100 comprises a procedure storing part 400, an operation processing part 500, a memory control part 600, an inter-unit communication part 700, a profile information correction part 300, and a unit control part 200. Other unit processing units 101 and . . . comprises also the same composition elements, for example, the processing unit 101 comprises a process contents storing part 401, an operation processing part 501, a memory control part 601, an inter-unit communication part 701, a profile information correction part 301, and a unit control part 201. Hereinafter, only with reference to the processing unit 100 and its composition elements, it explains typically. The processing units are connected mutually via a control bus 800 and inter-unit communication path 820-1, 2 . . . , and each of the processing unit is connected to a storing device (not shown) via a memory bus 810.

For example, a group comprised of the process contents storing part 400, the operation processing part 500, and the memory control part 600 can act as a usual processor (VLIW: Very Long Instruction Word processor). For example, it is also possible to realize the same function by the “flexible hardware” using the same technology as FPGA (Field Programmable Gate Array).

The operation of the processing unit can be changed according to the process contents (program) stored in the procedure storing part 400 of the processing unit itself. Specifically, there are four kinds of threads, i.e., a resources management thread (RC (resource core)) which performs resources management of the whole system, an optimization thread (OF (optimizing fork)) which performs optimization processing, an observation thread (PF (profiling fork)) which observes the behavior of the program, and collects and analyzes profile information, and an operation thread (CF (computing fork)) which performs execution of an application program. Each thread corresponds to four functions which can be carried out in the processing unit, i.e., a function that performs the contents management such as change of execution, a function that generates optimized code, a function that observes behavior of the program, and a function that executes the application program, respectively.

The processing unit 100 comprises a circuit for collecting the profile information (the profile information collection part 300). The profile information collection part 300 may have an operation function and a memory function, or have only a function to send information to the adjoining processing unit. The profile information collected in the part can be transferred to the other processing unit via the inter-unit communication path 820-1, 2 . . . by the inter-unit communication part 700.

The processing unit 100 while performing the resource management thread (RC) has a function that can change the internal state of the other processing units by accessing to the process control part of the other processing units via the control bus 800. For example, each of the processing units can be changed into arbitrary roles by changing the contents of the procedure storing part 400. Moreover, it is also possible to change the code (operation thread) of the application program performed in the processing unit into the code optimized more.

Although the role of the processing unit can also be statically decided before execution, it can also be dynamically changed during program execution by using said change function.

The observation thread (PF) observes the state of execution of the program in the operation processing thread (CF). The optimization thread (OF) obtains the more suitable program (object code) and processing form by using the profile result obtained by the observation thread (PF). Consequently, if it is judged that execution efficiency improves, the resources management thread (RC) uses said change function to change the system into the state that is more suitable for execution. On the contrary, if it is judged as a result of the observation by the observation thread (PF) that the execution efficiency in the operation thread (CF) is lowered, the resources management thread (RC) changes the role assignment of each processing unit so that it can change into the composition which is suitable for behavior observation and optimization of the program.

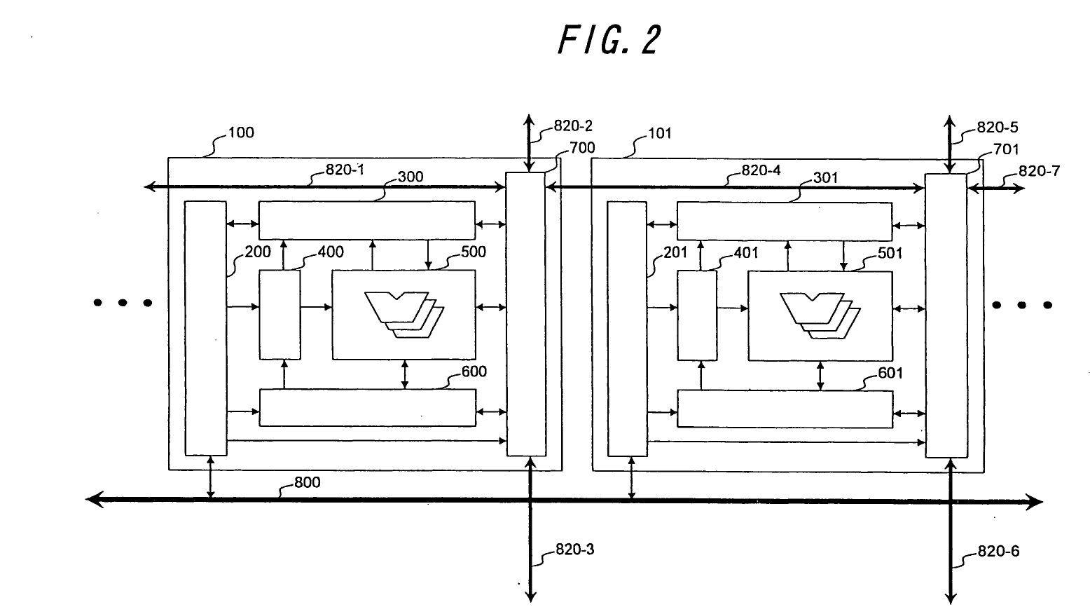

FIG. 2 is a block diagram showing an organization of a variation of the self-optimizing computer system shown in FIG. 1.

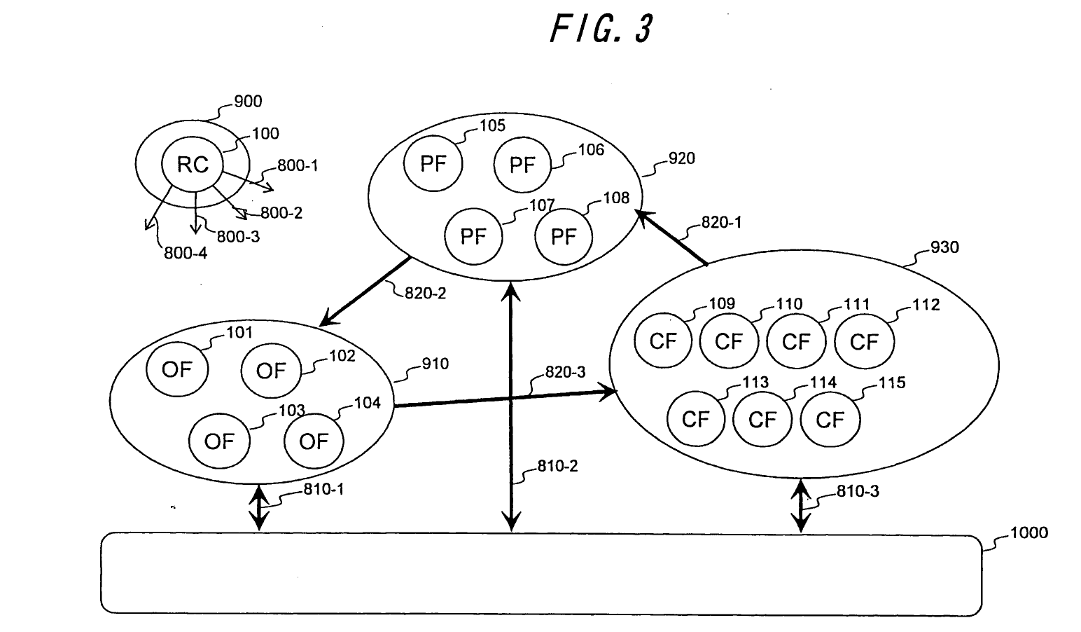

FIG. 3 is a block diagram explaining a fundamental concept of the self-optimizing computer system according to the invention. The processing units 100-115 are the unit processing units with internal organization as shown in FIG. 1. The sign (RC, PF, OF, CF) written in the round mark in this figure is the abbreviated name of the thread corresponding to the processing function currently performed in each processing unit. Ellipses 900-920 express the groups (processing unit groups) of the processing units divided for every processing function. The groups are comprised of a resources management processing unit group 900, an optimization processing unit group 910, an observation processing unit group 920, and an operation processing unit group 930. The resources management processing unit group 900 has a function which controls each processing unit in the system. For this purpose, each processing unit is accessed via a control bus (800-1, 2, . . . ). The application program is executed by the operation processing unit group 930. The behavior information of the program under execution is reported in detail to the observation processing unit group 920 via the inter-unit communication path 820-1. The observation processing unit group 920 analyzes this information to observe the state of execution of the program. If the execution efficiency in the operation processing unit group 930 is inadequate and there is room to optimize further, the collected profile information is transmitted to the optimization processing unit group 910 via the inter-unit communication path 820-2. The optimization processing unit group 910 generates the code for executing the program more efficiently. The generated code is transmitted to the operation processing unit group 930 under control of the resources management processing unit group 900. Then, if it is judged that the role assignment of each processing unit needs to be changed, the processing units belonging to each processing unit group are changed by control of the resources management processing unit group 900. Since each processing unit group stores information required in order to perform predetermined processing, it can access the memory storage 1000 via the memory bus 810-1, -2, and -3.

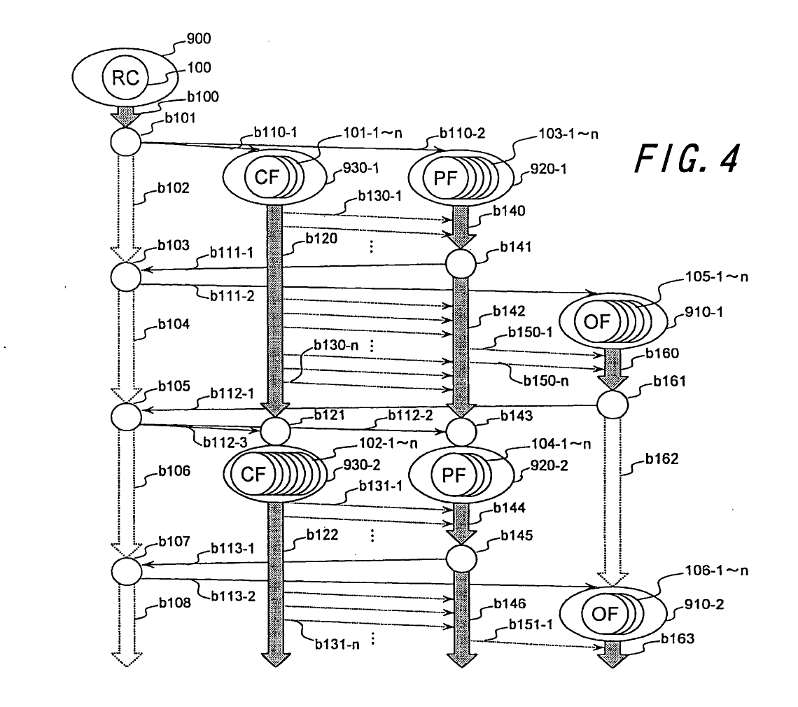

FIG. 4 shows operation of each of the processing unit groups of the self-optimizing computer system according to the invention in order of time. Reference numbers 100, 101-1-n, 102-1-n, 103-1-n, 104-1-n, 105-1-n, 106-1-n indicate said processing units respectively in this figure. The functional thread currently performed in each processing unit is outlined in a round mark like the above explanation. In this figure, an ellipse 900 is the resources management processing unit group, 930-1,930-2 are the operation processing unit groups, 920-1,920-2 are the observation processing unit groups, and 930-1, 930-2 are the optimization processing unit groups. The processing units are drawn in each of the processing unit groups. By drawing in piles the processing units assigned to each of the processing unit groups, it is expressing being processed in parallel inside the processing unit group concerned. Moreover, the change in the degree of pile is expressing increase and decrease of the number of the processing units assigned to the processing unit group. FIG. 4 is shown from the state when starting execution of the application program within the system. It is assumed that the application program is compiled beforehand and that the executable object code is prepared. First, the resources management processing unit group 900 operates to determine the role assignment of each of other processing unit, and to determine the unit processing units belonging to each of the operation processing unit group 930-1, the observation processing unit group 920-1, and the optimization processing unit group 910-1, respectively. Then the resources management processing unit group 900 determines the thread performed by other processing unit groups via the control bus, and prepares required setup etc. (b100). If preparation is completed, instructions (b110-1, b110-2) are sent to the operation processing unit group 930-1 and the observation processing unit group 920-1, and execution of each of the processing unit groups is started (b101). After the execution starts, since there is no role of the resources management processing unit group for the time being, the processing thread of the group is suspended (b102). The operation processing unit group 930-1 performs the given program (b120), and sends the information under execution to the observation processing thread (b130-1-n). The observation processing unit group 920-1 analyzes in detail the execution information sent from the operation processing unit group 930-1, and decides whether it became the situation that optimization is required (b140). If it is decided that optimization is required (b141), its information is sent to the resources management processing unit group 900 (b111-1). If this information is received, the resources management processing unit group 900 return from hibernation (b103), and activates of the optimization processing unit group 910-1 (b111-2). Then, the resources management processing unit group 900 is in hibernation, and it waits until the following event occurs (b104). After starting, the optimization processing unit group 910-1 receives the profile information of the program (b10-1-n) from the observation processing unit group 920-1, and performs optimization processing based on this information (b160). After optimization processing finishes (b-161), the optimization processing unit group notifies that to the resources management processing unit group 900 (b112-1), and is in hibernation (b162). The operation processing unit group 930-1 and the observation processing unit group 920-1 continue each execution as it is, while performing optimization processing by the optimization processing unit group 910-1 (b120, b142). If the resources management processing unit group 900 receives the notice of the optimization processing finish, it returns from hibernation (b105), and stops the operation processing unit 930-1 and the observation processing unit 920-1 temporarily (b112-2, b112-3). Then, the role assignment of each of the processing units is changed under management of the resources management processing unit group 900 (b121, b143). Consequently, it is changed into new composition and the operation processing unit group 930-2 and the observation processing unit group 920-2 are constructed. In this way, after changing so that the program can be performed more efficiently, operation of each of the processing unit groups 930-2,920-2 is started (b122, b144). Here, the application program performs the continuation from the time of being interrupted in b121. The operation (b131-1-n) which transmits the information under execution of the operation processing unit group 930-2 to the observation processing unit group 920-2 in detail is performed in like manner. If the observation processing unit group 920-2 detects the situation that the optimization is needed again (b145), in the same way as the operation after b141, the optimization processing unit group 930-2 sends the optimization request information to the resources management processing unit group 900 (b113-1), the resources management processing unit group 900 responds to the information, recovers from hibernation (b107), sends directions to the optimization processing unit group (910-2) (b113-2), and starts processing (b163). The optimization processing unit group 910-2 receives the required profile information from the observation processing unit group 920-2 (b151-1), and performs optimization processing (b163). In the meantime, the operation processing unit group 930-2 and the observation processing unit group 920-2 continue to perform (b122, b146).

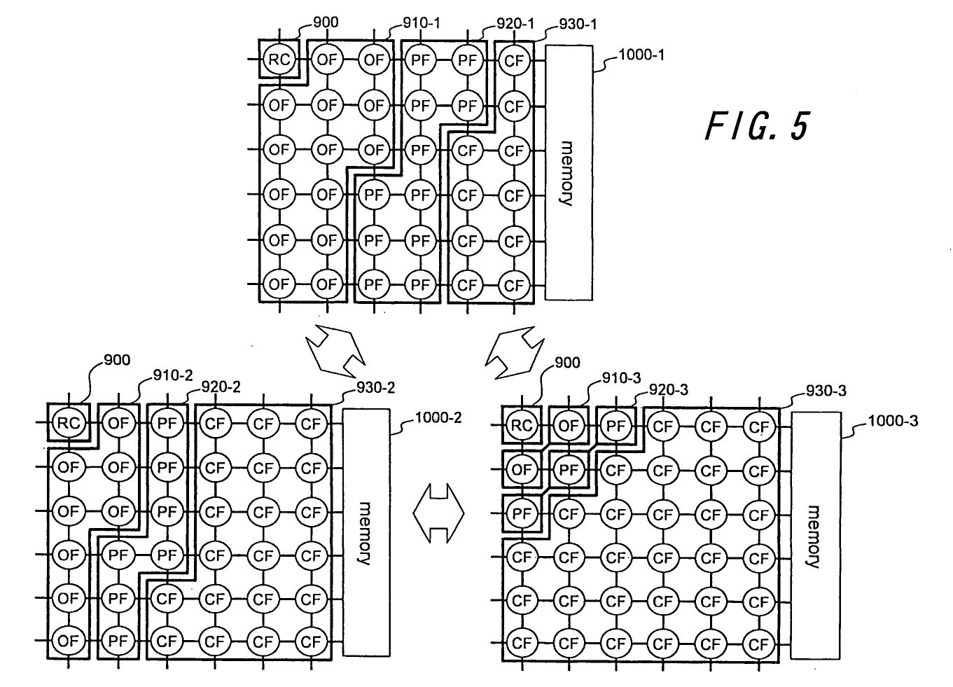

FIG. 5 illustrates the situation of change of the role assignment of each of the processing units shown in FIG. 4. This drawing consists of three drawings which show the situation of the role assignment of the processing unit of the system respectively. The upper drawing shows the situation that the optimization is not advanced much in the initial stage of the program. By assigning the many processing units to the observation processing unit group 920-1 and the optimization processing unit group 910-1, at the early stage of program execution, the object for optimization can be specified, and the optimization processing result can be obtained. The lower left-hand side drawing shows the situation that the optimization progressed to the degree in the middle. By assigning a little many processing units to the operation processing unit group 930-2, the processing performance is improved, at the same time, the point where optimization is further possible is looked for and optimized by the observation processing unit group 920-2 and the optimization processing unit group 910-2. The lower right-hand side drawing shows the situation that the optimization advanced highly. As a result of being optimized highly, a possibility of optimizing more becomes low. For this reason, the number of the processing units assigned to the observation processing unit group (920-3) and the optimization processing unit group (910-3) is decreased. The part is assigned to the operation processing unit group (930-3) so that the greatest processing performance is attained. As a result of observation by the observation processing unit group (920-3), if it is judged that the execution efficiency in the operation processing unit group (930-3) is getting worse, the resources management processing unit group 900 controls to change the assignment of each of the processing unit groups so that the optimal processing form according to the situation is attained by changing between these three drawings (as shown by bi-directional arrows in this figure).

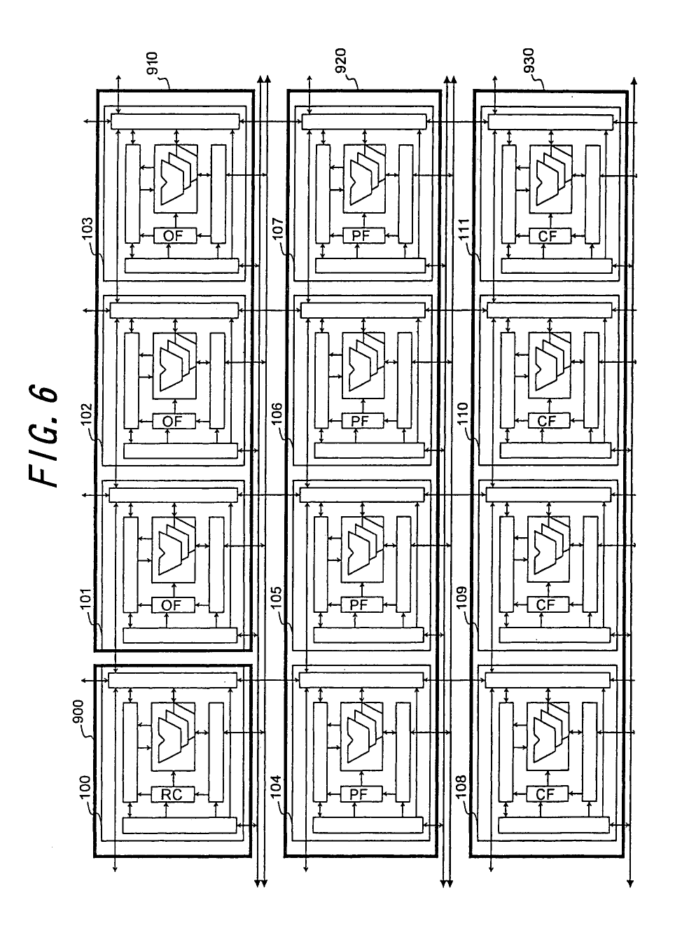

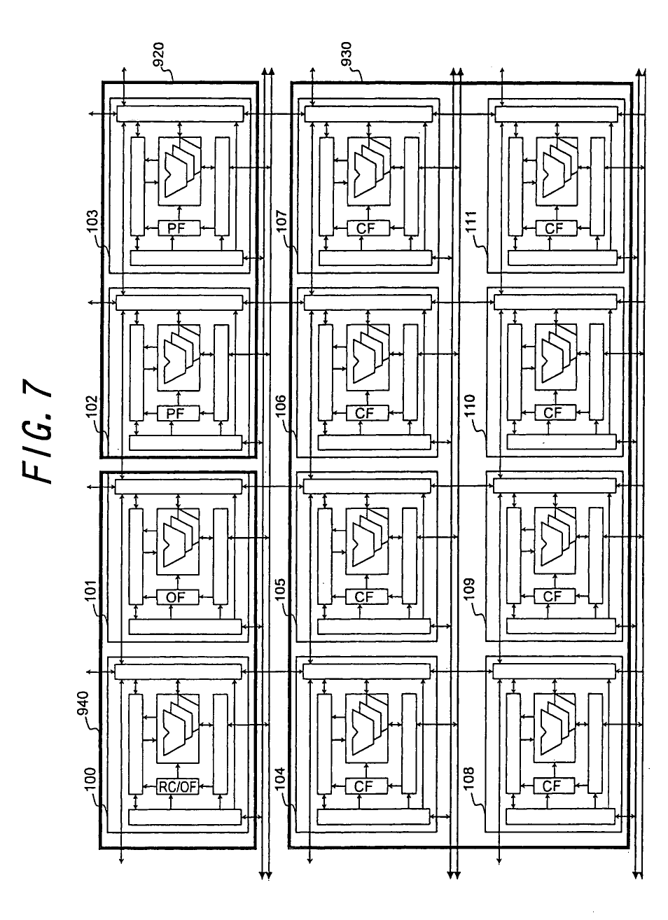

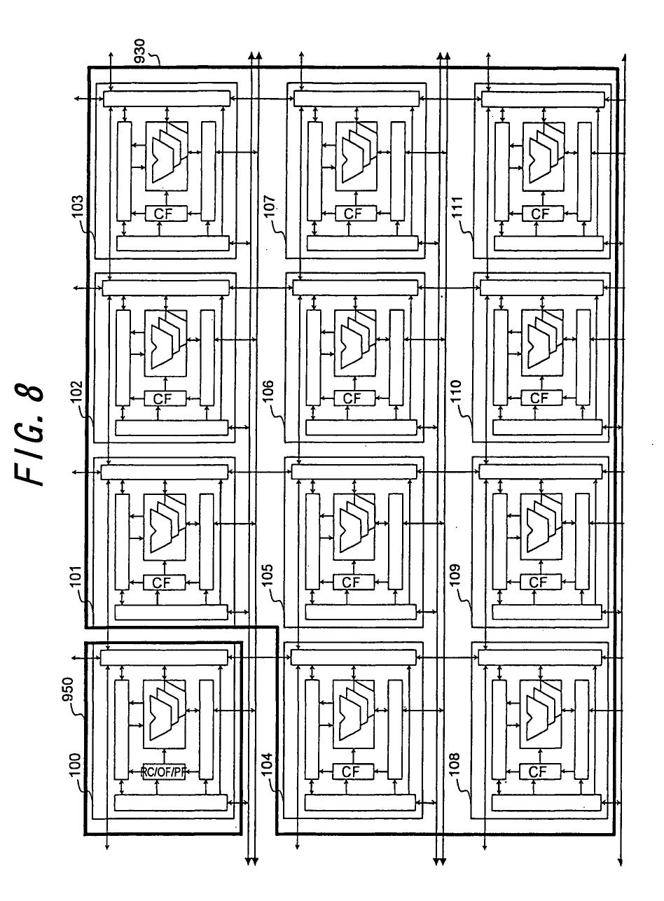

FIGS. 6-8 show each organization shown in FIG. 5 based on FIG. 1. In this figure, 100-111 show the unit processing unit respectively. In this figure, the number of each part in the processing unit is omitted. However, the contents of the functional processing currently performed in each of the processing unit is shown on the position of the procedure storing part of processing (400, 401 in FIG. 1) as the abbreviated name of the processing thread. For example, since the processing unit 100 of FIG. 6 executes the resources management thread, “RC” is written in the contents storing part. When starting execution of the application program (in the initial state), the role assignment as shown in FIG. 6 is performed. That is, the processing units are divided into the optimization processing unit group 910, the observation processing unit group 920, and the operation processing unit group 930 under management of the resources management processing unit group 900. If optimization processing advanced, as shown in FIG. 7, the ratio of the operation processing unit group 930 is increased, and the ratios of the observation processing unit group 920 and the optimization processing unit group 910 are decreased relatively. When there are few totals of the processing units, one processing unit is able to share two or more roles. In the case of FIG. 7, the processing unit 100 takes two roles; the resources management thread (RC) and the optimization thread (OF). By this reason, a resources management/optimization processing unit group 940 is created. FIG. 8 shows the state where the optimization advanced further and it is optimized to the maximum extent. Here, as a result of optimizing to the maximum extent, the situation which most of the processing units are assigned to the operation processing unit group 930 which manages execution of the program is shown. A few remaining processing units (one in FIG. 8) are assigned to the processes (RC, OF, PF) of resources management, optimization, and observation (a resources management/optimization/observation processing unit group 950).

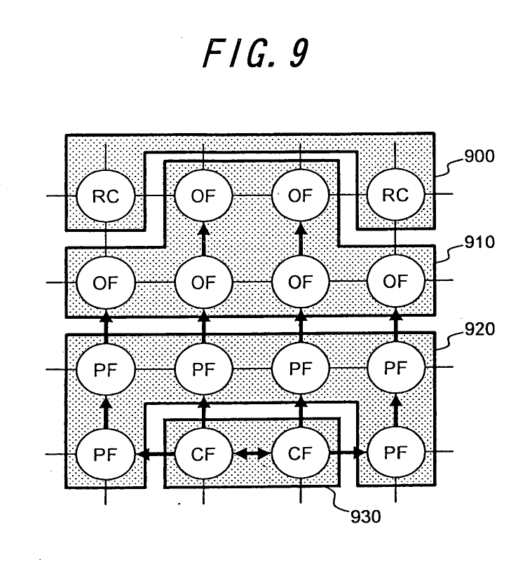

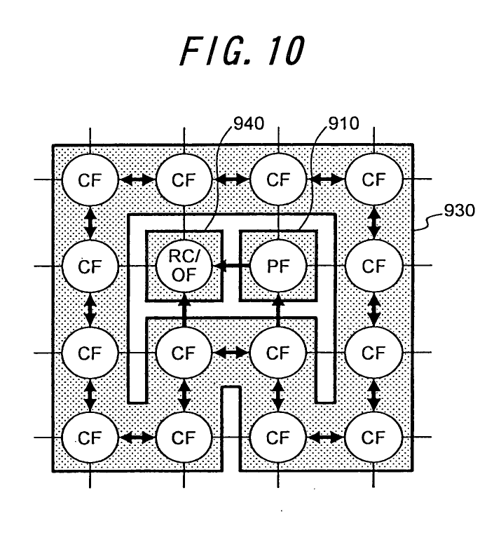

FIGS. 9 and 10 show examples of arrangement of each of the processing unit groups. For the sake of clarity, the area of the processing unit group is hatched. In the above explanation, only the number of the processing unit assigned to the processing unit group is mentioned, but a way of arrangement of these is not mentioned. In the embodiment of the invention mentioned above, since communication between the processing units is performed via the inter-unit communication path (820 in FIG. 1), if the processing unit groups are not arranged in consideration of the communicative situation, the information passing through the inter-unit communication path may carry out congestion, and it may become the factor which disturbs the improvement in the performance. For this reason, actually, it is necessary to consider the arrangement of the processing unit groups by which the load of the inter-unit communication path is decreased most. FIG. 9 is the example of arrangement of the processing unit groups in the state where the optimization less advanced (i.e. the initial state). Here, the two processing units are assigned to the operation processing unit group 930, and are communicating mutually. The observation processing unit group 920 is arranged so that the operation processing unit group 930 may be surrounded. Since the information on the execution behavior in the operation processing unit group flows toward an outside from the operation processing unit group 930, it does not disturb the communication inside the operation processing unit group. Furthermore, in the case of this figure, the result of the observation processing unit group 920 is considered as flowing without resistance to the optimization processing unit group 910. FIG. 10 is the example of the arrangement of the processing unit groups in the state where the optimization progressed more. In this example, the operation processing unit group 930 forms an annular communication path. The observation processing unit group 920 and the resources management/optimization processing unit group 940 are arranged so that communication along this annular communication path may not be disturbed.

According to the invention, in the computer system which realizes improvement in the speed of the application program by using the multiple processing units, dynamic optimization can be performed by using the information acquired during this application program execution, and, much more improvement in the speed can be achieved. Therefore, the invention is applicable in large fields which requires a high-speed processing performance, such as high-performance computer, general-purpose microprocessor, and embedded processors.

1. A self-optimizing computer system comprising multiple processing units, characterized in that each of the processing units operates as at least one of an operation processing unit for executing a program, an observation processing unit for observing the behavior of the program under execution, an optimization processing unit for performing an optimization process according to the observation result of the observation processing unit, and a resource management processing unit for performing a resource management process of whole of the system such as a change of the contents of execution.

2. A self-optimizing computer system as claimed in claim 1, characterized in that each of the processing units has a function that allows changing dynamically an execution state of the operation processing unit and the executive program itself, and the optimization processing unit generates an optimal program code in real time based on the observation result of the behavior of the program observed by the observation processing unit, and changes dynamically the executive contents of the operation processing unit.

3. A self-optimizing computer system as claimed in claim 1, characterized in that a ratio of the numbers of the operation processing unit, the observation processing unit, the optimization processing unit, and resource management processing unit is changed depending on the optimization state of the program.

4. A self-optimizing computer system as claimed in claim 2, characterized in that a ratio of the numbers of the operation processing unit, the observation processing unit, the optimization processing unit, and resource management processing unit is changed depending on the optimization state of the program.
